(19) United States
(12) Patent Application Publication
(10) Pub. No.: US 2019/0172145 A1
(43) Pub. Date: Jun. 6, 2019

(54) PEER-TO-PEER INVESTMENT INTERMEDIARY SYSTEM

(71) Applicants: Sinae KIM, Incheon (KR); Keonho KIM, Incheon (KR)

(72) Inventors: Sinae KIM, Incheon (KR); Keonho KIM, Incheon (KR)

(21) Appl. No.: 16/321,085

(22) PCT Filed: Aug. 14, 2017
(86) PCT No.: PCT/KR2017/008818

§ 371 Date: Jan. 28, 2019

(30) Foreign Application Priority Data
Aug. 24, 2016 (KR) 10-2016-0108020

(51) Int. Cl. G06Q 40/06; G06Q 20/06; G06Q 20/22; G06Q 40/02

(52) U.S. Cl. CPC G06Q 40/06; G06Q 40/025; G06Q 20/223; G06Q 20/065

(57) ABSTRACT

A peer-to-peer (P2P) investment intermediary system issues a bond certificate in a form of a virtual currency with respect to an investment of an investor, and then matches investment conditions of investors and loan conditions of debtors to intermediate an investment therebetween. The P2P investment intermediary system deducts a predetermined commission only in each investment transaction or bond transfer procedure, such that the investor may obtain a maximum return on investment, and the debtor may borrow funds with a minimum interest on a loan.

### TECHNICAL FIELD

The present invention relates to a peer-to-peer (P2P) investment intermediating platform 100, and specifically, to a P2P investment intermediating platform which includes investor terminals 120 respectively used by one or more investors 10, debtor terminals 130 respectively used by one or more debtors 20, and a P2P investment intermediating platform server 110 connected to the respective investor terminals and debtor terminals through a communication network,

wherein the P2P investment intermediating platform server 110 is configured to: receive investments (S1) to which investment conditions including an investment amount, a return on investment, an investment period and a return type on investment are added from the investors through the investor terminals 120; issue electronic currencies (S2) with respect to the investments to the investor terminals 120; receive loan applications (S3) to which loan conditions including at least one of a loan amount, a loan interest rate, and a loan period are added from the debtors through the debtor terminals 130; and set the return on investment by deducting a loan-deposit margin rate from the loan interest rate, then select an investment condition and a loan condition by matching the investment conditions and the loan conditions with each other, and then pay a loan (S4) to the debtor 20 through the debtor terminal 130 according to the selected investment condition and the loan condition, wherein, in a process of receiving the investment or paying the loan, the P2P investment intermediating platform server 110 performs the investment or the payment of loan by deducting a commission from the investment or the loan according to a rate of commission for the investment or the loan.

### BACKGROUND ART

As is well known, a loan business of financial institutions such as a bank and a credit company holds an important position in modern society. Since most of profits in the financial institutions are created by the loan business, each financial institution is trying to efficiently perform the loan business.

The loan business is a business that generates a predetermined economic power for a borrower secured on properties or credit of the borrower. Therefore, risk avoidance is the most important position, inter alia, and rapid processing for the loan business in the financial institution is more important than other things for the borrower.

Currently, a general credit review process conducted by the financial institution includes firstly inputting a resident registration number or corporation number repeatedly in contents of documents necessary upon an examination when examination documents are received, outputting input data on papers to be temporarily bound together, and then making six or seven copies to submit them to a decision-making organization by hand. Once decisions are made in the decision-making organization, the original documents are bound together and kept in a filing system. When any subsequent change occurs, it is necessary to find the corresponding documents kept in the filing system, update the changed contents and again bind together the documents. Similarly, when completing the repayment, processes of finding the corresponding documents from the filing system, and dispersing the same should be executed. As for the loan business related to such an existing financial loan, there are a lot of existing inventions including a configuration disclosed in “an integrated management system for financial money borrowing/loan business (Korean Patent Registration No. 10-0956934)” of Patent Document 1 below.

However, in a case of such a typical loan, first, the financial institution manages the money received from a lender, and then loans it to the borrower. Therefore, most of risks that the loan cannot be recovered are shared by the financial institutions. Thus, to avoid any further risk, the financial institutions may operate the loan by increasing a difference between an interest paid by the borrower and an interest received by the lender. Therefore, the borrower has to pay more interest than necessary, and the lender is forced to earn lower interest income than the possible interest income.

On the other hand, unlike the existing financial loans described above, there is a financing method which is a type of investment intermediating method of intermediating so that a borrower (debtor) who needs funds can directly borrow the funds after attracting investors, and the borrower pays a commission of a predetermined amount. As existing inventions related to such an investment intermediating method, there are a lot of known inventions including “an Internet-based investment intermediating server and an investment intermediating method thereof (Korean Patent Laid-open Publication No. 10-2001-0095986)” of Patent Document 2 below.

However, the existing investment intermediating methods described above are no more than a level of having characteristics that investment related information is merely processed through the Internet.

### SUMMARY OF INVENTION

### Problems to be Solved by Invention

In consideration of the above-mentioned circumstances, it is an object of the present invention to provide a peer-to-peer (P2P) investment intermediary system which issues a bond certificate in a form of a virtual currency with respect to an investment of an investor, and then matches investment conditions of investors and loan conditions of debtors to intermediate an investment therebetween, wherein the P2P investment intermediary system deducts a predetermined commission only in each investment transaction or bond transfer procedure, such that the investor may obtain a maximum return on investment, and the debtor may borrow funds with a minimum interest on a loan.

### Means for Solving Problems

To achieve the above objects, according to an aspect of the present invention, there is provided a peer-to-peer (P2P) investment intermediating platform, including: investor terminals 120 respectively used by one or more investors 10; debtor terminals 130 respectively used by one or more debtors 20; and a peer-to-peer (P2P) investment intermediating platform server 110 connected to the respective investor terminals and debtor terminals through a communication network, wherein the P2P investment intermediating platform server 110 is configured to: receive investments (S1) to which investment conditions including an investment amount, a return on investment, an investment period and a return type on investment are added from the investors through the investor terminals 120; issue electronic currencies (S2) with respect to the investments to the investor terminals 120; receive loan applications (S3) to which loan conditions including at least one of a loan amount, a loan interest rate, and a loan period are added from the debtors through the debtor terminals 130; and set the return on investment by deducting a loan-deposit margin rate from the loan interest rate, then select an investment condition and a loan condition by matching the investment conditions and the loan conditions with each other, and then pay a loan (S4) to the debtor 20 through the debtor terminal 130 according to the selected investment condition and the loan condition, wherein, in a process of receiving the investment or paying the loan, the P2P investment intermediating platform server 110 performs the investment or the payment of loan by deducting a commission from the investment or the loan according to a rate of commission for the investment or the loan.

In addition, the return type on investment may include a periodic type corresponding to one of daily, weekly, and monthly types, and when the return type on investment is designated as the periodic type, the P2P investment intermediating platform server 110 may add up the return on investment for the total interest income withdrawn from the debtors through the debtor terminals 130, and calculate an interest according to an investment ratio for each period designated in the return type on investment, and then pay the calculated interest to the investors 10 through the respective investor terminals 120 as a regular interest.

Further, the loan period may be designated by setting a specific period through the investor terminal 120 and is transmitted to the P2P investment intermediating platform server 110, the P2P investment intermediating platform server 110 may pay the regular interest on a quarterly or yearly basis prior to expiration of term of the designated investment period, and calculate an interest income from a time when the regular interest is already paid until the expiration of the designated investment, and pay the calculated interest income to the investor 10 through the investor terminal 120.

Further, the P2P investment intermediating platform server 110 may deposit an amount obtained by deducting amounts already paid to investors 10 and the commission from the interest incomes paid by the debtors 20 in accordance with the loan interest rate as a balance to operate based on the balance.

Further, the P2P investment intermediating platform server 110 may divide proportionally and calculates an amount obtained by periodically deducting accounts receivable from the balance in accordance with an investment amount ratio to the investors 10.

Further, after issuing the electronic currency, the investor terminal 120 of the investor 10, and the P2P investment intermediating platform server 110 may verify the electronic currency according to blockchains.

Further, the P2P investment intermediating platform server 110 may perform one-to-many selection by placing the plurality of debtors 20 into a group according to the loan condition.

Further, the P2P investment intermediating platform server 110 may perform many-to-one selection by placing the plurality of investors 10 into a group according to the investment condition.

Furthermore, the P2P investment intermediating platform server 110 may place the plurality of investors 10 into groups according to the investment conditions, and perform many-to-many selection by placing the plurality of debtors 20 into a group according to the loan condition.

In addition, the P2P investment intermediating platform may further include: a financial institution server 140 connected to the P2P investment intermediating platform server 110 through a communication network, wherein the P2P investment intermediating platform server 110 may use the loan condition by further including previous loan status information of the debtor 20 received through the financial institution server 140.

In addition, the P2P investment intermediating platform may further include: a credit rating agency server 150 connected to the P2P investment intermediating platform server 110 through a communication network, wherein the P2P investment intermediating platform server 110 may use the loan condition by further including credit information of the debtor 20 received through the credit rating agency server 150.

Further, the P2P investment intermediating platform server 110 may preliminarily select investment conditions and loan conditions by matching them with each other, when the investment conditions and the loan conditions do not match each other, preliminarily select investment conditions and loan conditions which are closest to each other, and transmit and notify a fact of preliminary selection to the investor terminal 120 and the debtor terminal 130 of the investor and the debtor who present the investment condition and the loan condition corresponding to the preliminary selection, respectively.

### Advantageous Effects

According to the P2P investment intermediary system of the present invention, it is possible to issue a bond certificate in a form of a virtual currency with respect to an investment of an investor, and then match investment conditions of investors and loan conditions of debtors to intermediate an investment therebetween, as well as, it is possible to deduct a predetermined commission only in each investment transaction or bond transfer procedure, such that the investor may obtain a maximum return on investment, and the debtor may borrow funds with a minimum interest on a loan.

In addition, according to the present invention, it is possible to disperse a risk such as a decrease in an interest income due to an early-redemption of the debtor after jointly operating a balance and then distribute the same, as well as, other investors can obtain additional profits, such that the profits of the investor may be maximized, and a financial market may be further activated.

### BRIEF DESCRIPTION OF THE DRAWINGS

FIG. 1 is a block diagram illustrating a P2P investment intermediary system according to an embodiment of the present invention.

FIG. 2 is a diagram illustrating a basic operation of the P2P investment intermediary system according to the embodiment of the present invention.

FIG. 3 is a schematic diagram illustrating one-to-one investment mediation of the P2P investment intermediary system according to the embodiment of the present invention.

FIG. 4 is a schematic diagram illustrating one-to-many investment mediation of the P2P investment intermediary system according to the embodiment of the present invention.

FIG. 5 is a schematic diagram illustrating many-to-one investment mediation of the P2P investment intermediary system according to the embodiment of the present invention.

FIG. 6 is a schematic diagram illustrating many-to-many investment mediation of the P2P investment intermediary system according to the embodiment of the present invention.

### MODE FOR CARRYING OUT INVENTION

Hereinafter, a peer-to-peer (P2P) investment intermediary system according to the embodiment of the present invention will be described in detail with reference to the accompanying drawings. First, it should be noted that, referring to the drawings, wherein like reference characters designate like or corresponding parts throughout the several views. In the description of the present invention, the publicly known functions and configurations that are judged to be able to make the purport of the present invention unnecessarily obscure will not be described.

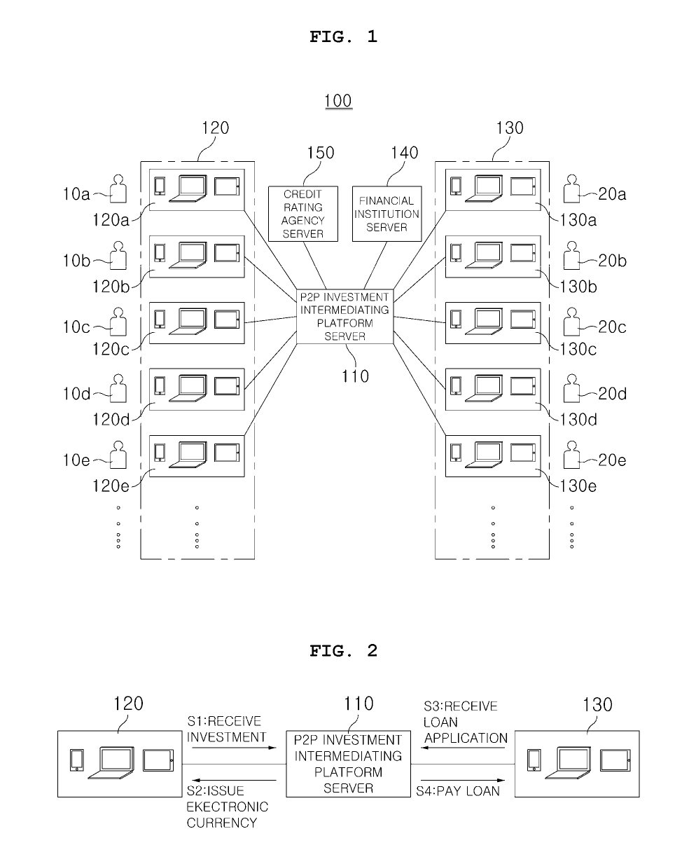

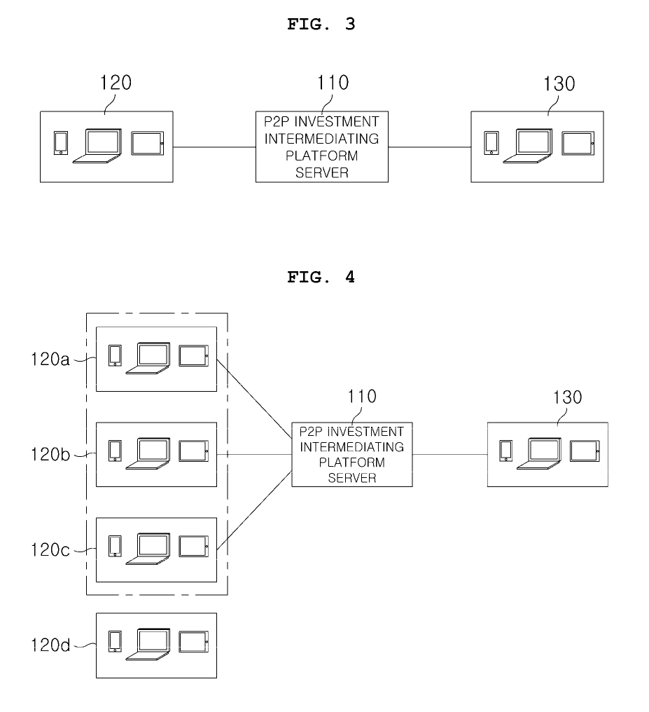

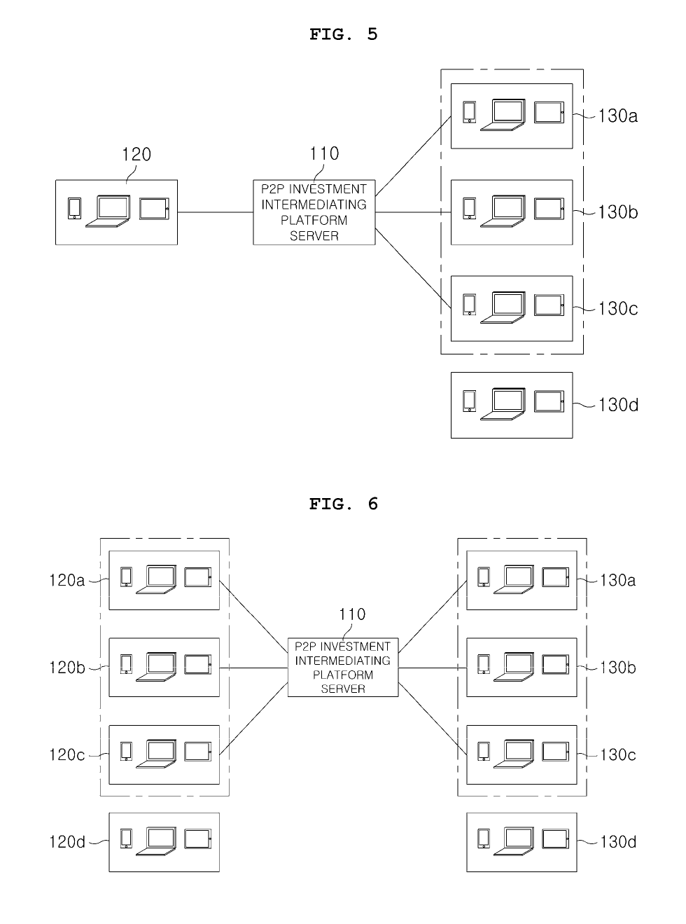

As illustrated in FIG. 1, a peer-to-peer (P2P) investment intermediating platform of the present invention generally includes investor terminals 120 respectively used by one or more investors 10, debtor terminals 130 respectively used by one or more debtors 20, and a peer-to-peer (P2P) investment intermediating platform server 110 connected to the respective investor terminals and debtor terminals through a communication network. In this disclosure, the ‘investor’ refers to a user who wishes to invest a predetermined amount of money using the P2P investment intermediary system according to the embodiment of the present invention, and the ‘debtor’ refers to a user who wishes to receive a loan using the P2P investment mediation matching system according to the embodiment of the present invention. Meanwhile, in the present invention, in consideration of a fact that one or more of the investors 10 may exist, when collectively referring to or there is no need to separately divide, the investors are presented by an “investor 10’ using reference numeral “10,” whereas when it is necessary to divide the investors, the investors are divisively presented by denoting lowercase alphabetical letters such as “10a,” “10b” and . . . in the reference numeral (these also apply to a case of the debtors in the same manner).

Meanwhile, the investor terminal 120 and the debtor terminal 130 include any one of means capable of being operated with a predetermined program installed therein, for example, a desktop computer, as well as a portable terminal such as a smart phone, a notebook, and a tablet PC used by the investor 10 or the debtor 20.

Generally, as illustrated in FIG. 1, the P2P investment intermediating platform of the present invention is preferably further connected to at least one of a financial institution server 140 and a credit rating agency server 150 through a communication network.

Hereinafter, an operation of a P2P investment intermediating platform 100 included in the P2P investment intermediary system according to an embodiment of the present invention will be described.

First, a basic investment-loan matching operation will be described. In this case, as illustrated in FIG. 2, the P2P investment intermediating platform server 110 receives investments (S1) to which investment conditions including an investment amount, a return on investment, an investment period and a return type on investment are added from the investors through the investor terminals 120, and issues electronic currencies (S2) with respect to the investments to the investor terminals 120. In this case, the electronic currency has a function of a kind of bond certificate, and has an important function that enables a free and easy bond transfer as described below.

Meanwhile, the P2P investment intermediating platform server 110 receives loan applications (S3) to which loan conditions including at least one of a loan amount, an interest rate, and a loan period are added from the debtors through the debtor terminals 130. Thereafter, the P2P investment intermediating platform server 110 sets the return on investment by deducting a loan-deposit margin rate from the loan interest rate, then selects an investment condition and a loan condition by matching the investment conditions and the loan conditions with each other. In other words, the P2P investment intermediating platform server sets the return on investment by deducting the loan-deposit margin rate from the loan interest rate, so that the loan interest rate is larger than the return on investment, and thereby it is possible to secure a difference needed to operate a balance which will be described below. Then, the P2P investment intermediating platform server 110 pays a loan (S4) to the debtor 20 through the debtor terminal 130 according to the selected investment condition and the loan condition. Meanwhile, in a process of receiving the investment or paying the loan, it is preferable that the P2P investment intermediating platform server 110 performs the investment or the payment of loan by deducting a commission from the investment or the loan according to a rate of commission for the investment or the loan.

In this case, for the operation of selecting the investment condition and the loan condition by matching them with each other, most basically, it is preferable to select a case in which the investment conditions presented by several investors and the loan conditions presented by several debtors are shared with each other (for example, by matching an investor and a debtor whose investment condition and loan condition coincide with each other). Meanwhile, there may be a case in which the investment condition and the loan condition are set to a predetermined range (for example, a return on investment of 8 to 12% per year) rather than a case in which the investor designates one fixed value (for example, a return on investment of 10% per year). Accordingly, in this case, for the operation of selecting the investment condition and the loan condition by matching them with each other, it is also preferable to select a case in which the investment conditions presented by several investors and the loan conditions presented by several debtors are shared with each other (for example, when a return on investment designated by an investor is 8 to 12% per year, and a loan rate applied for by the debtor is 7 to 9% per year, the return on investment and the loan rate are duplicated in a range of 8 to 9% per year, which will be selected to be regarded as they are shared with each other by matching). When performing the matching process, as described above, it is preferable to set the return on investment by deducting the loan-deposit margin rate from the loan interest rate in order to operate a balance, then match the investment conditions and the loan conditions with each other.

On the other hand, there may be a case in which the investment conditions and the loan conditions respectively presented by the investors or the debtors do not match each other, as described above. In this case, the P2P investment intermediating platform server 110 preliminarily selects investment conditions and loan conditions which are closest to each other (for example, when an investor presents a return on investment of 8 to 12% per year, if debtors a, b and c present loan rates of 4 to 5% per year, 5 to 6% per year and 6 to 7% per year, respectively, the debtor c who presents the loan rate of 6 to 7% per year which is closest to the return on investment of 8 to 12% per year presented by the investor is preliminarily selected). Meanwhile, in the case of such a preliminary selection, since the investor and the debtor are not matched or shared with each other in terms of the investment condition and loan condition desired by each of them, it is not preferable to automatically perform the investment intermediating matching. Accordingly, in order to notify the investor and the debtor that they have been preliminary selected, and allow them to change or adjust the investment condition and the loan condition with each other, it is preferable that the P2P investment intermediating platform server 110 transmits and notifies the fact of preliminary selection to the investor terminal 120 and the debtor terminal 130 of the investor and the debtor who present the investment condition and the loan condition corresponding to the preliminary selection, respectively.

Meanwhile, it is preferable to provide various types of investments or loans to the investors or debtors. For this purpose, preferably, the P2P investment intermediating platform 100 according to the embodiment of the present invention is configured so that the return type on investment constituting the investment condition includes a periodic type corresponding to one of daily, weekly, and monthly types. In this case, when the return type on investment is designated as the periodic type, the P2P investment intermediating platform server 110 adds up the return on investment for the total interest income withdrawn from the debtors through the debtor terminals 130, and calculates an interest according to an investment ratio for each period designated in the return type on investment, and then pays the calculated interest to the investors 10 through the respective investor terminals 120 as a regular interest. In this case, when the return on investment is set by deducting the loan-deposit margin rate from the loan interest rate as described above, if all the interest income is paid on schedule, the total interest income becomes larger than a sum of the regular interest paid to the investors. Therefore, it is possible to secure funds to operate based on the balance for preparation and dispersion of the risk to be described below.

In addition, the loan period may not be specially set (that is, when the investor does not specify the period of withdrawing the investment), or the loan period may be set to a specific period. When the loan period is designated by setting a specific period through the investor terminal 120 and is transmitted to the P2P investment intermediating platform server 110, it is preferable that the P2P investment intermediating platform server 110 pays the regular interest on a quarterly or yearly basis prior to expiration of term of the designated investment period, calculates an interest income from a time when the regular interest is already paid until the expiration of the designated investment, and pays the calculated interest income to the investor 10 through the investor terminal 120.

Meanwhile, in order to prepare and disperse the risk when the loan is not withdrawn from the debtor or the scheduled interest income is terminated early due to an early redemption of the debtor, it is preferable that the P2P investment intermediating platform server 110 deposits an amount obtained by deducting amounts already paid to investors 10 and the commission from the interest incomes paid by the debtors 20 in accordance with the loan interest rate as a balance to operate based on the balance. In other words, it is possible to preserve or disperse the risk (for example, to guarantee a loss of a predetermined ratio with respect to the investor whose investment is not withdrawn) by efficiently operating the secured balance.

Meanwhile, it is preferable that the P2P investment intermediating platform server 110 divides proportionally and calculates an amount obtained by periodically deducting accounts receivable from the balance in accordance with an investment amount ratio to the investors 10, so that it is possible not only to preserve and disperse the risk caused by the operation of the balance but also to generate more profit to be paid to the investors. In other words, if there is any remaining balance which remains after handling the risk such as an amount receivable by operating the balance, it is preferable to divide proportionally and calculate the remaining balance, thus generate more profit to be paid to the investors.

In addition, when the P2P investment intermediating platform server 110 is further connected to the credit rating agency server 150 through the communication network, the P2P investment intermediating platform server 110 preferably uses the loan condition by further including credit information of the debtor 20 received through the credit rating agency server 150.

Furthermore, when the P2P investment intermediating platform server 110 is further connected to the financial institution server 140 through the communication network, the P2P investment intermediating platform server 110 preferably uses the loan condition by further including previous loan status information of the debtor 20 received through the financial institution server 140.

Meanwhile, it is possible that the P2P investment intermediating platform server 110 matches one or more of the investors 10 and one or more of the debtors 20 by placing them into groups in any one form of one-to-one, one-to-many, many-to-one, and many-to-many depending on the investment conditions and the loan conditions, respectively. That is, it is also possible to perform the investment intermediating matching by placing a plurality of investors having similar investment conditions into one group, or placing a plurality of debtors having similar loan conditions into one group. Thereby, it may be especially useful when matching an investor who has invested a large amount with a plurality of debtors who desire a small loan amount, and it is possible to place a plurality of debtors who desire a large loan amount into a group, and match the same with the investor who has invested a large amount or the like, and thereby play a role in activating financial transactions by further enhancing the possibility of investment intermediation.

Meanwhile, financial transactions such as the investment or the payment of the loan may be made through the Internet remittance or the like, which is performed in the P2P investment intermediating platform server 110, the investor terminal 120, and the debtor terminal 130, and it is also possible to pay the loan through various types of electronic currencies as necessary.

As described above, optimal embodiments have been disclosed in the drawings and the specification. Although specific terms have been used herein, these are only intended to describe the present invention and are not intended to limit the meanings of the terms or to restrict the scope of the present invention as disclosed in the accompanying claims. Accordingly, those skilled in the art will appreciate that various modifications and other equivalent embodiments are possible from the above embodiments. Therefore, the scope of the present invention should be defined by the technical spirit of the accompanying claims.

1. A peer-to-peer (P2P) investment intermediating platform, comprising:
investor terminals respectively used by one or more investors; debtor terminals respectively used by one or more debtors; and a peer-to-peer (P2P) investment intermediating platform server connected to the respective investor terminals and debtor terminals through a communication network,
wherein the P2P investment intermediating platform server is configured to:
receive investments to which investment conditions including an investment amount, a return on investment, an investment period and a return type on investment are added from the investors through the investor terminals; issue electronic currencies with respect to the investments to the investor terminals;
receive loan applications to which loan conditions including at least one of a loan amount, a loan interest rate, and a loan period are added from the debtors through the debtor terminals; and
set the return on investment by deducting a loan-deposit margin rate from the loan interest rate, then select an investment condition and a loan condition by matching the investment conditions and the loan conditions with each other, and then pay a loan to the debtor through the debtor terminal according to the selected investment condition and the loan condition,
wherein, in a process of receiving the investment or paying the loan, the P2P investment intermediating platform server performs the investment or the payment of loan by deducting a commission from the investment or the loan according to a rate of commission for the investment or the loan.

2. The P2P investment intermediating platform according to claim 1, wherein the return type on investment includes a periodic type corresponding to one of daily, weekly, and monthly types, and
when the return type on investment is designated as the periodic type, the P2P investment intermediating platform server adds up the return on investment for the total interest income withdrawn from the debtors through the debtor terminals, and calculates an interest according to an investment ratio for each period designated in the return type on investment, and then pays the calculated interest to the investors through the respective investor terminals as a regular interest.

3. The P2P investment intermediating platform according to claim 2, wherein the loan period is designated by setting a specific period through the investor terminal and is transmitted to the P2P investment intermediating platform server,
the P2P investment intermediating platform server pays the regular interest on a quarterly or yearly basis prior to expiration of term of the designated investment period, and
calculates an interest income from a time when the regular interest is already paid until the expiration of the designated investment, and pays the calculated interest income to the investor through the investor terminal.

4. The P2P investment intermediating platform according to claim 3, wherein the P2P investment intermediating platform server deposits an amount obtained by deducting amounts already paid to investors and the commission from the interest incomes paid by the debtors in accordance with the loan interest rate as a balance to operate based on the balance.

5. The P2P investment intermediating platform according to claim 4, wherein the P2P investment intermediating platform server divides proportionally and calculates an amount obtained by periodically deducting accounts receivable from the balance in accordance with an investment amount ratio to the investors.

6. The P2P investment intermediating platform according to claim 1, wherein, after issuing the electronic currency, the investor terminal of the investor, and the P2P investment intermediating platform server verifies the electronic currency according to blockchains.

7. The P2P investment intermediating platform according to claim 1, wherein the P2P investment intermediating platform server performs one-to-many selection by placing the plurality of debtors into a group according to the loan condition.

8. The P2P investment intermediating platform according to claim 1, wherein the P2P investment intermediating platform server performs many-to-one selection by placing the plurality of investors into a group according to the investment condition.

9. The P2P investment intermediating platform according to claim 1, wherein the P2P investment intermediating platform server places the plurality of investors into groups according to the investment conditions, and
performs many-to-many selection by placing the plurality of debtors into a group according to the loan condition.

10. The P2P investment intermediating platform according to claim 1, further comprising:
a financial institution server connected to the P2P investment intermediating platform server through a communication network,
wherein the P2P investment intermediating platform server uses the loan condition by further including previous loan status information of the debtor received through the financial institution server.

11. The P2P investment intermediating platform according to claim 1, further comprising:
a credit rating agency server connected to the P2P investment intermediating platform server through a communication network,
wherein the P2P investment intermediating platform server uses the loan condition by further including credit information of the debtor received through the credit rating agency server.

12. The P2P investment intermediating platform according to claim 1, wherein the P2P investment intermediating platform server preliminarily selects investment conditions and loan conditions by matching them with each other,
when the investment conditions and the loan conditions do not match each other, preliminarily selects investment conditions and loan conditions which are closest to each other, and
transmits and notifies a fact of preliminary selection to the investor terminal and the debtor terminal of the investor and the debtor who present the investment condition and the loan condition corresponding to the preliminary selection, respectively.
